(19) United States
(12) Patent Application Publication
(10) Pub. No.: US 2014/0031731 A1
(43) Pub. Date: Jan. 30, 2014

(54) RELATING TO A THERAPEUTIC FOOT SUPPORT

(71) Applicants: Anna Waugh, Staffordshire (GB); Neil James Waugh, Staffordshire (GB)

(72) Inventors: Anna Waugh, Staffordshire (GB); Neil James Waugh, Staffordshire (GB)

(21) Appl. No.: 13/950,142

(22) Filed: Jul. 24, 2013

(30) Foreign Application Priority Data
Jul. 26, 2012 (GB) 1213348.4

(51) Int. Cl. A61G 13/12

(52) U.S. Cl. CPC A61G 13/125
USPC 602/15; 428/542.8

(57) ABSTRACT

FIG. 1 shows a foot support 10 for use by a user having a static posture, to provide support for a foot of the user. With support 10 comprise a section 2 which is upright, in use, to support the forefoot. Sections 1, 3 wrap around, in use, to provide side support to the foot. A U-shaped section 4 supports the ankle in user. A cut out (not visible) receives the heel, in use, to relieve pressure on the heel when the foot is supported vertically.

### CROSS REFERENCE TO RELATED APPLICATION

This application claims priority from United Kingdom Patent Application No. 1213348.4, filed Jul. 26, 2012, which application is incorporated herein by reference in its entirety.

### BACKGROUND

The present invention relates to therapeutic support for posture and pressure relief.

It is acknowledged that individuals who have a tendency to develop habitual destructive postures will be vulnerable to distortion of foot shape which will compromise skin integrity, muscle tone and motor performance. Postural care supports people to adopt symmetrical postures with the feet in a neutral position, particularly in supine lying, and may involve the individual being in static postures for unusually long periods; therefore there is a need to make the supporting structures as pressure relieving, safe hygienic and comfortable as possible. The scope of therapeutic support is vast, affecting a significant proportion of the population. The beneficiaries from provision of an enhanced understanding and provision of postural care include three broadly identifiable groups:

1. Those who are easily identifiable with a movement difficulty, regardless of diagnosis, for example, older people and people with disability.

2. Those who have no apparent movement problems but, when measured, have developed body shape distortion: for example those with scoliosis or athletes whose performance may be depleted by asymmetry of body shape.

3. Those whose postural case needs are transient during episodes of reduced mobility such as post-surgery, rehabilitation, stroke or trauma.

### SUMMARY OF INVENTION

Examples of the present invention provide a foot support for use by a user having a static posture, to provide support for a foot of the user, the support comprises a U-shaped section which, in use, supports the ankle and at least one section which is wrapped around the U-shaped section, in use, to provide side support to the foot.

Examples of the invention may be embodied as a blank for use in forming a foot support as previously defined, the blank being generally planar and comprising a first region to provide an upright section, a second region extending from the first region to provide a wrap around region, and a third region extending from the first region to provide a U-shaped region.

Accordingly, examples of the present invention may be implemented as a flat packed shaped pad of non woven fibre of key qualities which can be used to wrap around and fixed to enhance support and positioning for the feet of people who remain in static postures. In use, the foot support may be positioned in close relation to the user so that their body may benefit from the key qualities of the pad.

### INTRODUCTION TO THE DRAWINGS

An example embodiment of the invention will now be described by referring to the accompanying drawings, in which:

FIG. 1 illustrates the flat pack shape of the foot support viewed from the top which can be scaled up or down in size to suit different sized users;

FIG. 2 illustrates to flat pack shape of the foot support viewed from the bottom which can be scaled up or down in size to suit different sized users;

FIG. 3 illustrates the assembled foot support which, can be fixed, shaped and adjusted to suit different sized individuals and different supported postures.

FIGS. 4 to 6 are schematic diagrams of a blank for forming a second example of a support, the blank being shown at various stages of formation; and

FIG. 7 is a perspective view of the second example support.

### OVERVIEW

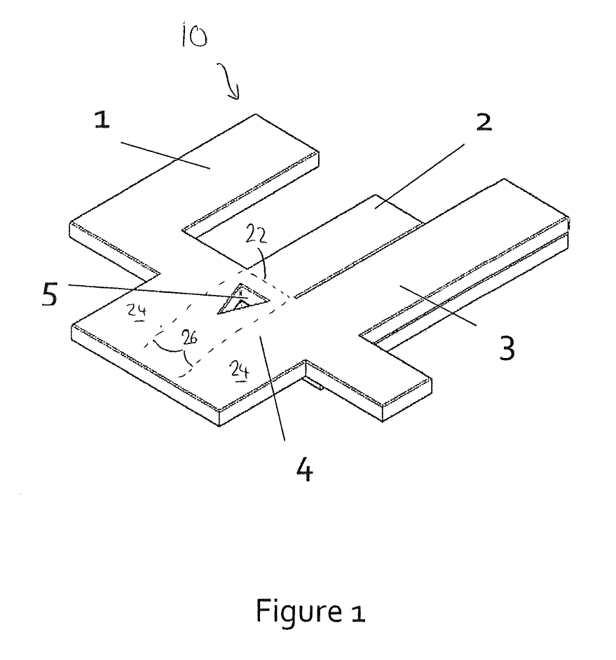

The example support 6 of FIGS. 1 to 3 has the following features to be described in more detail below:
a. A wrap around 1 section to provide side support for the foot.
b. An upright section 2 to provide vertical support to the forefoot.
c. A reinforced wrap 3 around section to provide side support to the foot and lateral stabilising support to stabilise the forefoot vertically.
d. A section 4 to be folded into a U-shape to support the heel and ankle.
e. A cut out section 5 into which the heel will be cradled in order to relieve pressure on the heel when the foot is supported vertically.

In use, the user's foot will be supported in close relation to the foot support so that their body can relate to the key properties of the pad, as will be described.

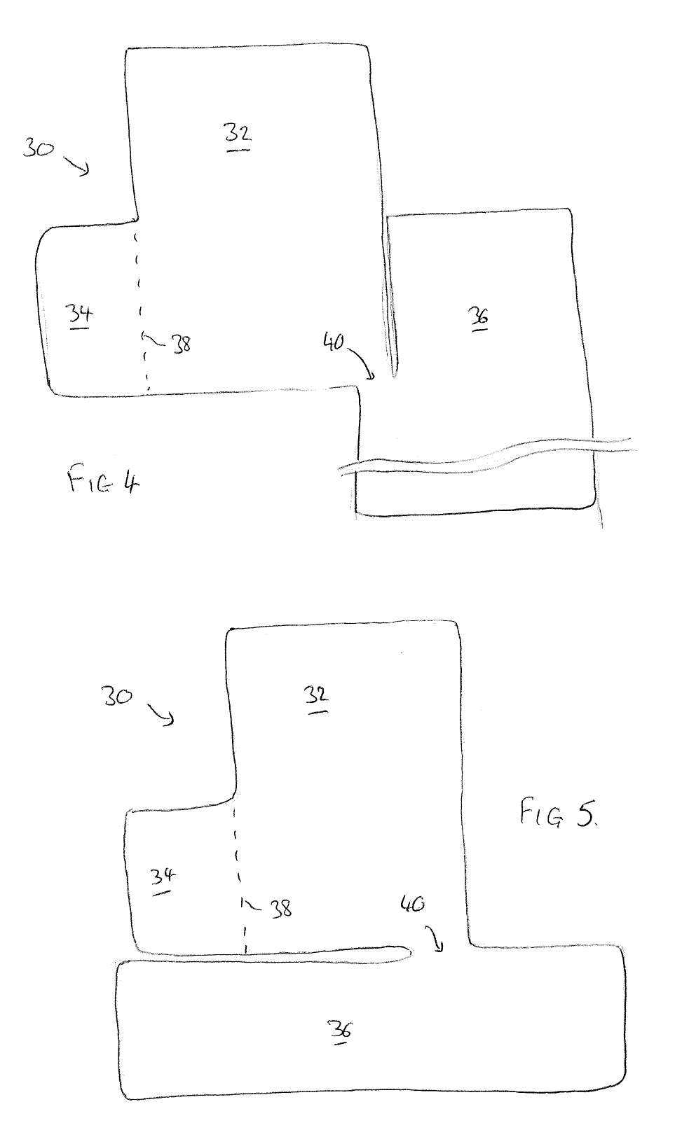

The example of FIGS. 4 to 7 has the following features, to be described in more detail below:

a U-shaped section 36 which, in use, supports the ankle; and a section 12 which is wrapped around the U-shaped section 36, in use, to provide side support to the foot.

This example also has a section 14 which is upright, in use, to support the forefoot against extending the ankle.

### First Example

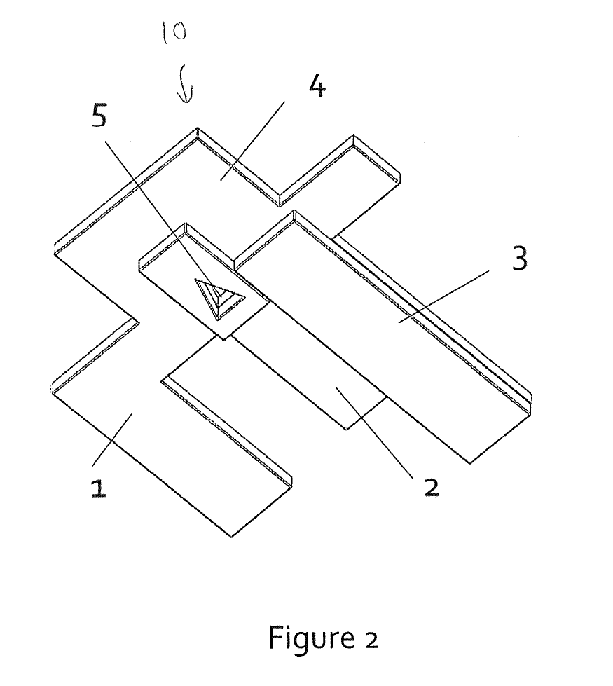

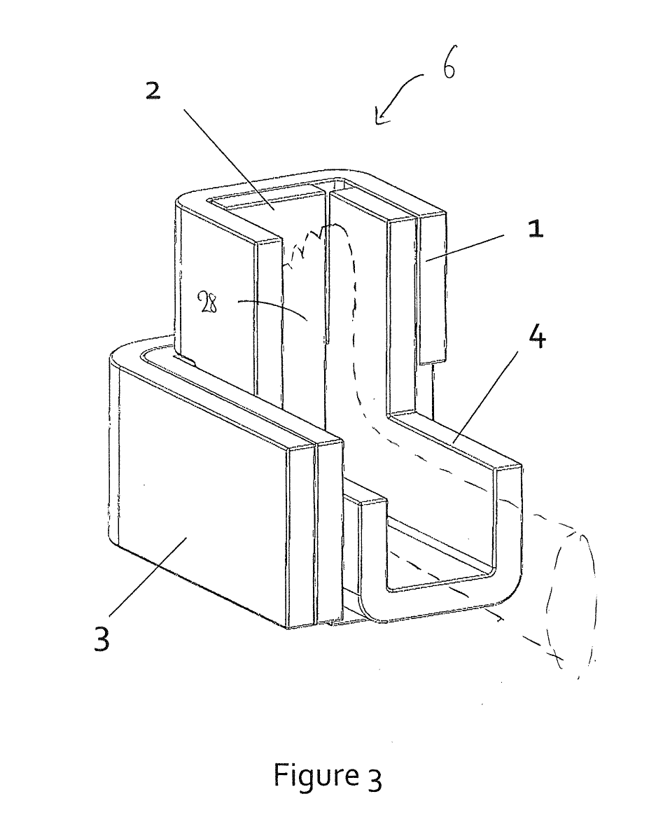

In more detail, the first example support 6 can be provided in a flat-pack form (FIGS. 1 and 2) for forming into the support 6 of FIG. 3. The blank 10 of FIGS. 1 and 2 is generally planar except where it is locally reinforced, as will be described. The blank is a sheet of pad material, such as a resilient foam.

The blank 10 has a first region indicated by the reference numeral 2 to provide the upright section 2 (FIG. 3). The region 2 and hence the upright section 2 are generally rectangular. A second region 3 of the blank 10 provides a wrapped around region in the finished support 6 (FIG. 3). The region 3 is also generally rectangular. The region 3 extends away from the first region 2, being connected through a third region 4 which can be formed into the U-shape section (FIG. 3) and is also generally rectangular in this example. An aperture 5 is formed in the third region 4, to form a cut-out for the heel, in the assembled support 6 (FIG. 3).

FIG. 1 shows the top view of the blank 10. The support 6 is assembled by first folding the upright section 2 up from the plane of the blank 10 at a fold line 22. Next, the sides 24 of the U-shaped section 4 are folded up from the plane of the blank 20, at fold lines 26. This places the first wrap around section 1 further above cut-out 5 than the second wrap around section 3. Both wrap around sections 1, 3 can now be wrapped around the upright section 2 to form the finished support 6, shown in FIG. 3.

It can be seen from FIGS. 2 and 3, in particular, that the blank 10 is locally reinforced by additional material thickness in the region of the wrap around section 3 so that when the support 6 has been fully formed, the wrap around section 3 provides additional material to one side of the U-shaped section 4, as compared with the other side. Thus, when a foot 28 is placed in the U-shaped portion 4, as indicated in broken lines in FIG. 3, the additional material of wrap around section 3 provides reinforcement which provides side support to the foot 28, preferentially in one direction. The result is to give lateral stabilising support to the foot 28 and in particular to stabilise the forefoot in the generally vertical position illustrated in FIG. 3. In addition, the upright section 2 supports the forefoot against extending the ankle.

### Second Version

FIGS. 4 to 7 illustrate a second version of a blank 30 for forming a foot support. Again, the blank 30 is generally planar and made of a pad material such as a resilient foam. The blank 30 has a first region 32 to provide the upright section of the support being formed. A second region 34 extends from the first region 32 to provide a wrap around region. In this example, only a single wrap around region is provided.

The blank 30 also provides a third region 36 which extends from the first region to provide the U-shaped region of the support being formed. The first region 32 is generally rectangular. The second region 34 is connected with the first region 32 along a fold line 38. The third region 36 is connected with the first region 32 at a location 40. The location 40 provides a region at which the material of the blank is deformable to allow the third region 36 to move relative to the first region 32 to a final orientation as illustrated in FIG. 5. This is achieved by a form of twisting action of the third region 36 relative to the first region 32, within the common plane of the first and third regions 32, 36.

Once the third portion 36 has been twisted relative to the first portion 32, to the condition illustrated in FIG. 5, the ends of the third region 36 can be folded up at fold lines 42 as indicated in FIG. 6, to form a U-shaped section 36. The upright portion 32 is also folded up out of the original plane of the blank 30, with further deformation taking place at the location 40.

When the condition of FIG. 6 is reached, edges of the U-shaped section 36 can be secured to edges of the upright section 32, by stitching, adhesive or other appropriate means.

The adjacent edges of the upright section 32 and the base of the U-shaped section 36 can also be secured together in similar manner. However, it is preferred to leave a central region unsecured. This is indicated at 43. This leaves a slot for receiving the heel of the user, corresponding with the cut-out section 5 of the first example.

FIG. 6 illustrates one end of the U-shaped section 36 already folded up from the original plane and the other end still lying in the original plane, but broken lines indicate the position to be occupied by the other end of the U-shaped section 36, after folding up.

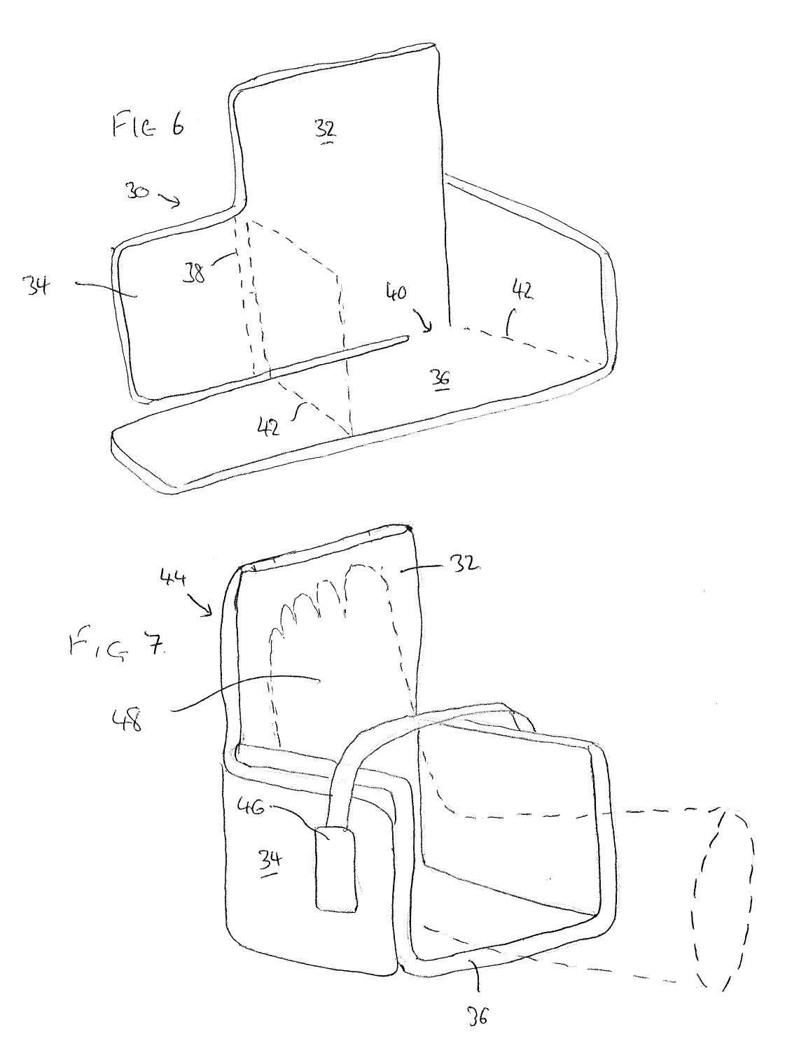

The final stage of formation of the support is to wrap the section 34 around the adjacent end of the U-shaped section 36. Again, appropriate arrangements such as sewing, adhesive or the like can be used to secure the wrapped section 34 in this position, illustrated in FIG. 7. This completes the support 44.

It can be seen from FIG. 7 that the wrapped section 34 provides additional material to one side of the foot, as compared with the other side of the foot. This provides side support to the foot. In particular, this lateral stabilising support will stabilise the forefoot to remain supported in the generally vertical position illustrated in FIG. 7.

In this example, a quick release strap 46 is provided (shown only in FIG. 7) to assist in retaining the foot in the support 44. A similar strap (not shown) can be incorporated in the support 6 of FIGS. 1 to 3.

### Use of the supports

The two supports 6, 44 can be used in a similar manner. Accordingly, for simplicity, the use of the support 44 will now be described. The skilled reader will readily understand from this description how to use the support of FIGS. 1 to 3, in a similar manner.

Once the support 44 has been fully formed as described above , the foot 48 is placed in the U-shaped section 36 and the strap 46 is secured to hold the support 44 in place around the foot 48. In this position, as can be seen particularly from FIG. 7, the sole of the foot 48 of a supine user will rest against the upright section 32, with the ankle and lower calf received in the U-shaped section 36.

Some users who require postural support when supine will have a tendency for the foot 48 to roll out, away from the other foot. Other users will have a tendency for their foot to roll in, toward the other foot. The significance of the wrapped section 34 is to provide additional support against this unrequired movement. For example, in the situation illustrated in FIG. 4 the wrapped section 34 sits outside the left foot 48 of the user, providing additional material to support the foot 48 against turning out. However, it can readily be understood that if the right foot of the user was placed in the support 44, the foot would be supported against turning in.

A left foot can be supported against turning in, and a right foot against turning out, by forming a support 44 from a blank 30 which is a minor image of the blank illustrated in FIG. 4, so that the wrap around section 34 provides additional support adjacent the other side wall of the U-shaped section 36.

It is also to be noted from FIG. 7 that the upper extremity of the upright section 32 is above the height of the toes of the foot 48. This allows the upright section 32 to support the weight of bed clothes without that weight being transferred to the foot of the user, which might otherwise exacerbate the tendency of the foot 48 to turn to an inappropriate posture.

In the examples described above, the fibre in the pad has key properties so the user remains safe and comfortable with regards to pressure, texture, temperature, hygiene and sensation. The fibre is a non woven material which allows air to pass through it, thereby keeping the person's feet cool. This also draws moisture away from the body so that the person's feet do not have to lie on damp materials should they sweat excessively.

People who have movement problems and more complex disability may also have continence issues and some may be doubly incontinent. The foot support can be washed to 95 degrees centigrade, eliminating the risks associated with bacteria and infection. The hygienic and washable properties of the foot support will ensure the person can be kept comfortable and clean. Use of the foot support will reduce sweating that can cause saturation and degradation of the skin which contributes to skin breakdown and pressure sores. By increasing air circulation and ventilation of the skin surface the pad will enhance a healthy condition of the skin and underlying tissues.

The fibre used in the pad is an anti-mite and anti-fungal material which will enhance the hygienic condition of the user. This is particularly important if the foot support is being used by more than one person, as can happen within health, education or social service settings. The washable properties of the foot support reduce the risk or cross infection of such conditions as MRSA and C-Difficile.

The foot support is particularly useful for people with movement problems and complex healthcare needs because it is hygienic, safe and comfortable. However, it can also be used by people without any associated healthcare needs as it is simple in design and flexible. Properties of the foot support mean that containment support, which will reduce surface area directly exposed to the air, can be applied to the user without increasing heat or sweating. The increased surface area which can be safely applied to the individual by use of the foot support will reduce pressure areas and protect the individual from pressure sores. The preferred comfortable support applied to the individual by the foot support can have the effect of reducing abnormality of muscle tone and allowing the person to relax in the required attitude. Desirably, destructive postures will be prevented by the application of the therapeutic support provided by the foot support.

We claim:

1. A foot support for use by a user having a static posture, to provide support for a foot of the user, the support comprising:
a. a U-shaped section which, in use, supports the ankle, and b. at least one section which is wrapped around the U-shaped section, in use, to provide side support to the foot.

2. A foot support according to claim 1, comprising a section which is upright, in use, to support the forefoot against extending the ankle.

3. A foot support according to claim 1, wherein at least one wrapped around section is adjacent a side wall of the U-shaped section and attached thereto to provide an increased thickness of material alongside the foot to provide side support to the foot.

4. A foot support according to claim 1, wherein the U-shaped section and the wrapped around section are made of sheet material and the faces of the sections are adjacent.

5. A foot support according to claim 1, wherein at least one of the upright sections, the or a wrapped around section and the U-shaped section is formed from sheet material.

6. A foot support according to claim 5, wherein the or each section formed of sheet material is formed from a common sheet.

7. A foot support according to claim 5, wherein the sheet material is a pad material for pressure relief.

8. A foot support according to claim 5, wherein the sheet material is resilient.

9. A foot support according to claim 5, wherein the sheet material is covered by a breathable material.

10. A support according to claim 1, wherein at least one of the wrapped around sections is reinforced.

11. A support according to claim 1, made from a material which is anti-mite.

12. A support according to claim 1, made from a material which is anti-fungal.

13. A support according to claim 1, further comprising a strap extending between the side walls of the U-shaped section to retain the support in position around the foot of the user, during use.

14. A support according to claim 1, further comprising a cut out section in which the heel is received, in use, to relieve pressure on the heel when the foot is supported vertically.

15. A support according to claim 14, wherein the cut out section is provided by a gap between the U-shaped section and the upright section.

16. A blank for use in forming a foot support as defined in claim 1, the blank being generally planar and comprising:
a. a first region to provide the upright section;
b. a second region extending from the first region to provide a wrapped around region;
c. a third region extending from the first region to provide the U-shaped region.

17. A blank according to claim 16, wherein the first region is generally rectangular.

18. A blank accord to claim 16, wherein the second region is generally rectangular.

19. A blank accord to claim 16, wherein the second region is generally connected with the first region along a fold line.

20. A blank according to claim 16, wherein the third region is connected with the first region along a line at which the material of the blank is deformable to move the third region, relative to the first region for an initial orientation to a final orientation.

21. A blank according to claim 16, wherein the third region is connected with the first region to move by twisting within the common plain of the first and third regions.
